(19) United States
(12) Patent Application Publication
(10) Pub. No.: US 2009/0229947 A1
(43) Pub. Date: Sep. 17, 2009

(54) PAPER CURRENCY HANDLING APPARATUS AND AUTOMATED TELLER MACHINE

(76) Inventors: Tomoyo Takai, Owariasahi (JP); Yuji Nagaya, Seto (JP); Genta Ogawa, Seto (JP); Tomoyasu Kato, Nagoya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/323,528

(22) Filed: Nov. 26, 2008

(30) Foreign Application Priority Data
Mar. 12, 2008 (JP) 2008-062002

(51) Int. Cl. G07F 7/04; G07F 9/08

(52) U.S. Cl. 194/206; 194/217

(57) ABSTRACT

A paper currency handling apparatus capable of determining destination of each paper currency based on currency identification result before conveyance into a temporal storage if the order of paper currencies entered by user varies within the temporal storage. The apparatus has a conveyance path conveying paper currencies, an identification portion identifying each paper currency conveyed, a storage portion storing identification information indicating identification result of each paper currency identified by the identification portion, and a control portion controlling various portions. The identification portion reads unique information about each paper currency conveyed along the conveyance path. The storage portion stores the unique information about the currency read by the identification portion and the identification information about the currency identified by the identification portion by associating these information with each other.

### INCORPORATION BY REFERENCE

The present application claims priority from Japanese application JP 2008-062002 filed on Mar. 12, 2008, the content of which is hereby incorporated by reference into this application.

### BACKGROUND OF THE INVENTION

The present invention relates to a paper currency handling apparatus having a function of accepting and returning paper currencies based on the results of identification of the currencies.

EU and other countries have regulations for counterfeit currency. In particular, when a paper currency is entered into a paper currency handling apparatus, if the apparatus has determined that the currency is a counterfeit or dubious bill, the currency shall not be handed down to the user. In order to obey the regulations, it is important in money deposit transactions that paper currencies be transported to destinations complying with identification information indicating the results of identification of the paper currencies.

A prior-art paper currency handling apparatus is equipped with a winding type temporal storage for winding each paper currency around a rotary drum to store the currency. In the winding type temporal storage device, it is rare that the order in which paper currencies are stored in the temporal storage is different between when entered money is counted and when the entered money is received. Therefore, the paper currency handling apparatus equipped with the temporal storage of the winding type successively stores sets of identification information (such as denominations, as to whether genuine or counterfeit, and their status) about paper currencies identified by processing for counting entered money. During processing for receiving the entered money, the paper currencies are conveyed out from the temporal storage either in the same order in which they were received in the temporal storage or in the reverse order. Based on this premise, the apparatus can determine the destinations of the paper currencies based on the identification information complying with the order.

A conventional paper currency handling apparatus as disclosed in Japanese Patent No. P3865171 (Patent Document 1) has been proposed. When entered money is counted, information about identification of the paper currencies is stored, as well as information about positions inside a temporal storage. When entered money is received, destinations of the paper currencies are determined based on the stored information about the identification of the currencies and on the information about the positions inside the temporal storage.

### SUMMARY OF THE INVENTION

The winding type temporal storage described in Patent Document 1 receives paper currencies at low efficiency and, therefore, it is impossible to cope with miniaturization and increased capacity of paper currency handling apparatus. Furthermore, the cost is high, because special members are used. For these reasons, in recent years, stack type temporal storages which receive paper currencies at high efficiency, provide low costs, and receive a stack of the paper currencies have been often used.

However, in the stack type temporal storage, the order in which paper currencies are stored in the temporal storage may be different between when entered money is counted and when the entered money is received. In this case, the order in which paper currencies are conveyed out from the temporal storage during the processing for receiving entered money is neither the same order in which paper currencies were received in the temporal storage at the time when entered money was counted nor the reverse order. As a result, if destinations of the currencies are determined based on identification information complying with the order used when entered money was counted, the currencies will be conveyed to inappropriate destinations not associated with the results of identification of the currencies.

In such a case, if a non-genuine or dubious paper currency is conveyed into a recycling storage and if the suspicious currency is handed down to a user's hand in the next transaction, the regulations are violated.

It is an object of the present invention to provide a paper currency handling apparatus capable of determining destinations of paper currencies conveyed out from a temporal storage based on identification information when the currencies are conveyed into the temporal storage even if the order of the paper currencies within the temporal storage is different between when the currencies are conveyed into the temporal storage and when the currencies are conveyed out from the temporal storage.

According to the present invention, the above and other objects are achieved by the features described in the following.

According to one feature of the present invention, a paper currency handling apparatus is offered which has a conveyance path along which paper currencies are conveyed, an identification portion for identifying the paper currencies conveyed in the conveyance path, storage portions for storing identification information indicating results of identification of the currencies performed by the identification portion, and a control portion for controlling the portions. The identification portion reads unique information about the paper currencies conveyed in the conveyance path. The storage portion stores the unique information about the currencies read by the identification portion and the identification information about the currencies identified by the identification portion by associating these two kinds of information with each other.

According to another feature of the invention, a paper currency handling apparatus is offered which has a temporal storage for temporarily storing paper currencies, a conveyance path along which the currencies are conveyed, an identification portion mounted to be able to read unique information about the currencies conveyed into the temporal storage through the conveyance path, a control portion for determining destinations of the paper currencies conveyed out to the conveyance path from the temporal storage based on the identification information about the currencies conveyed into the temporal storage from the conveyance path obtained as a result of identification of the currencies performed by the identification portion, and storage portions for storing the unique information read by the identification portion such that the unique information is correlated with the destinations.

According to a further feature of the invention, a paper currency handling method is offered which consists of identifying conveyed paper currencies, reading unique information about the conveyed currencies, and storing the read unique information about the currencies and identification information indicating results of identification of the currencies by associating these two kinds of information with each other.

According to the present invention, if the order of paper currencies within a temporal storage is different between when the currencies are conveyed into the temporal storage and when the currencies are conveyed out from the temporal storage, the currencies can be managed appropriately.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic vertical cross section of a paper currency handling apparatus.

FIG. 2 is a control block diagram of an automated teller machine.

FIG. 3 is a schematic perspective view of the automated teller machine.

FIG. 4 is a schematic diagram illustrating one example of temporal storage in which paper currencies are wound around a rotary drum and stored.

FIG. 5 is a schematic diagram showing an example of temporal storage in which paper currencies are stacked and stored.

FIG. 6 is a schematic diagram illustrating information stored when paper currencies are entered.

FIG. 7 is a schematic diagram illustrating processing performed when paper currencies are taken out from a temporal storage.

FIG. 8 is a view of one example of teller screen.

FIG. 9 is a flowchart illustrating processing in money deposit transactions.

FIG. 10 is a flowchart illustrating processing for canceling a money deposit transaction.

FIG. 11 is a flowchart illustrating processing for receiving paper currencies.

FIG. 12 is a flowchart illustrating processing performed when conveyance of paper currencies is stopped.

### DETAILED DESCRIPTION OF THE EMBODIMENTS

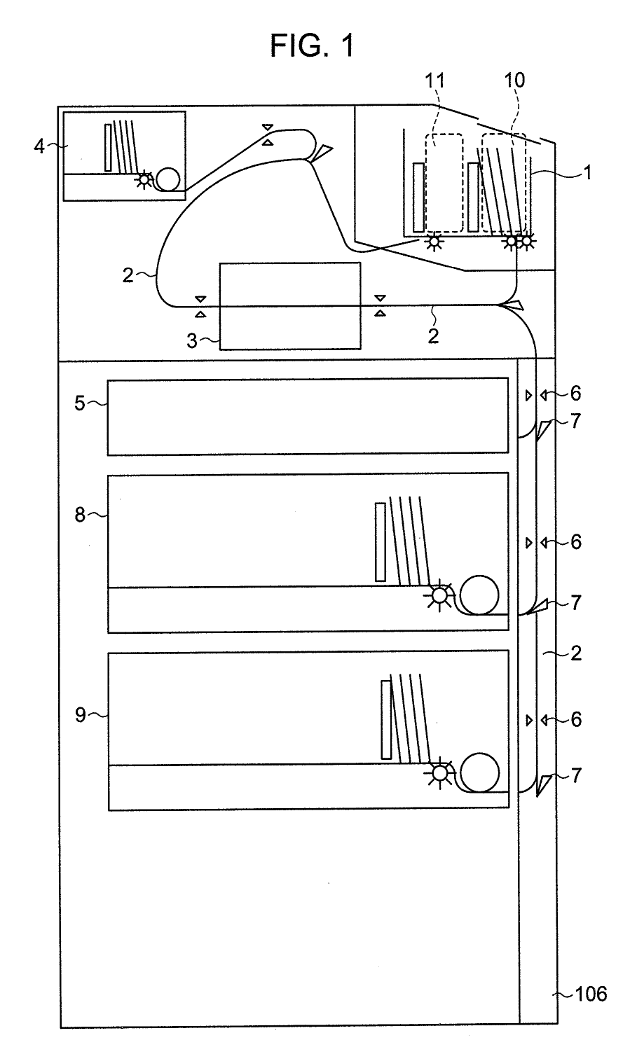

One embodiment of the present invention is hereinafter described with reference to FIGS. 1-8.

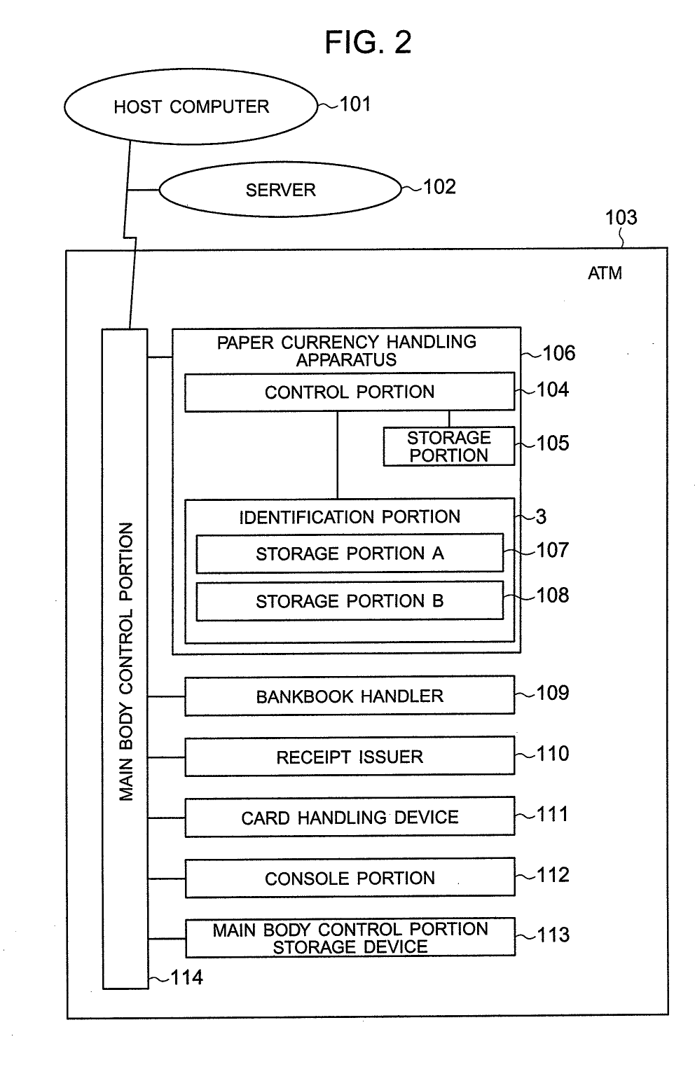

FIG. 1 shows a paper currency handling apparatus 106 handling paper currencies, indicating one function and one unit or apparatus of an automated teller machine (ATM) 103 (described later in connection with FIG. 2). The paper currency handling apparatus 106 has a cash reception-delivery portion 1 for accepting paper currencies entered by a user or client or delivering paper currencies that a user wants, a conveyance path 2 for conveying the paper currencies, and an identification portion 3 for identifying each conveyed paper currency in terms of denomination, genuine/fake, or status. Especially, the identification portion 3 has a function or means of reading unique information (e.g., a serial number printed on the currency or other information intrinsic or unique to the currency, the serial number including alphabetical or non-alphabetical letters and numbers) about the currency. Furthermore, the handling apparatus includes a temporal storage 4 for temporarily storing paper currencies, a reject storage compartment or a reject storage 5 for receiving paper currencies not adapted for circulation, a passage sensor 6 for detecting passage of paper currencies conveyed in the conveyance path 2, a gate 7 for switching the direction of conveyance of paper currencies, storage compartments 8, 9 for receiving paper currencies, and a control portion (not shown).

The cash reception-delivery portion 1 includes a hopper 10 for accepting paper currencies entered by a user and a reject stacker 11 principally used to deliver or return rejected paper currencies to the user. The storage compartments 8 and 9 are recycling compartments having a recycling function of using entered paper currencies as delivered paper currencies. In particular, paper currencies received in the storage compartments 8 and 9 may be used as delivered paper currencies when a transaction is performed by a subsequent user. For example, paper currencies of a large denomination (e.g., Japanese 10,000-yen denomination) are received in the storage compartment 8. Paper currencies of a small denomination (e.g., Japanese 1,000-yen denomination) are received in the storage compartment 9. The apparatus is preset such that the entered currencies can be recycled. The paper currencies received in the reject storage 5 are not used when transactions are performed by subsequent users. Hence, the reject storage 5 does not have the recycling function.

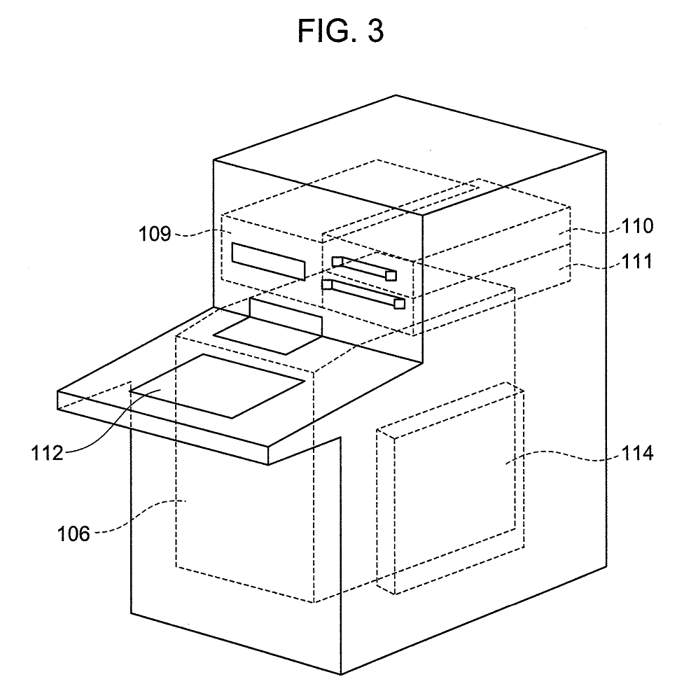

FIG. 2 is a control block diagram of the automated teller machine (ATM) 103 connected with a host computer 101 and with a server 102, the ATM including the paper currency handling apparatus 106. The ATM 103 is installed in a financial institution such as a bank or in a convenience store. The outer appearance of the ATM 103 is shown in FIG. 3. The host computer 101 and server 102 are at a higher hierarchical level than the ATM 103 and send and receive transaction information to and from the ATM 103. Furthermore, the host computer 101 and server 102 manage client information and store clients' account numbers and the deposit amounts at the accounts. A control portion 104 included in the paper currency handling apparatus 106 determines destinations of paper currencies by operation of the gate 7 of FIG. 1, controls conveyance of paper currencies along the conveyance path 2, and controls various units including the cash reception-delivery portion 1, identification portion 3, storage portions 105, 107, 108 and so on constituting the handling apparatus 106. In this way, the control portion 104 controls the whole paper currency handling apparatus 106. Programs, software, middleware, and other information for providing this control are stored in the storage portion 105, which in turn may constitute a part of the control portion 104.

As described in connection with FIG. 1, the identification portion 3 judges whether each paper currency is genuine or counterfeit, and identifies the denomination. Furthermore, the identification portion reads unique information about the currency. In one of the features of the identification portion 3, it is equipped with two storage portions, i.e., a first storage portion A and a second storage portion B. The storage area may be made of a single hardware storage unit, and the storage area may be divided into plural portions for storing information. Also, in this form, the first and second storage regions are defined. When paper currencies temporarily stored in the temporal storage 4 are conveyed into their destinations determined by the control portion 104, the first storage region 107 stores the unique information about the currencies identified by the identification portion 3. Meanwhile, the second storage portion 108 stores the unique information about the currencies read by the identification portion 3, the identification information (denominations of the currencies and information indicating whether they are genuine or fake or status) identified by the identification portion 3, and money reception order information (the order in which paper currencies are conveyed when entered money is counted) when paper currencies are conveyed into the cash reception-delivery portion 1 during so-called counting of paper currencies.

A bankbook (deposit book) handler 109 handles bankbooks and chiefly operates to make entries into or update the bankbooks and printing on them. A detail list issuer 110 prints the contents of transactions performed by a user and issues a receipt of record of transactions. A card handling device 111 reads or writes magnetic stripes stuck on magnetic stripe cards or IC chips attached on IC cards. A console portion 112 displays a control screen about manipulations that can be handled by the ATM (automated teller machine) 103, and accepts inputs for manipulations from users, clerk in charge, and maintenance personnel. A main body control portion 114 controls the whole ATM. A main body control portion storage device 113 stores a program necessary for the control.

The user carries out various transactions through the ATM 103. Typical transactions are money deposit transactions and payment transactions. During a money deposit transaction, if a user inserts paper currencies into the cash reception-delivery portion 1 and checks the sum of money on the console portion 112, there are two cases. In one case, the sum is good, and a check (OK) button is depressed, thus terminating the transaction. In the other case, the user depresses the return button to return the inserted currencies, thus terminating the transaction. To satisfy these different requirements from the user, the paper currency handling apparatus 106 already described in connection with FIGS. 1 and 2 can implement two major functions or processing operations (i.e., processing for counting entered money and processing for receiving entered money) in one money deposit transaction. Among them, the processing for counting entered money performed by the paper currency handling apparatus 106 is first described.

The processing for counting the entered money performed by the paper currency handling apparatus 106 consists of separating paper currencies one by one from the hopper 10 of the cash reception-delivery portion 1 and conveying out them onto the conveyance path 2 when the currencies are inserted into the cash reception-delivery portion 1 by the user. Each paper currency conveyed in the conveyance path 2 is identified in terms of denomination and as to whether or not it is genuine by the identification portion 3. Furthermore, unique information about the currency is read. At this time, the control portion 104 determines the destination of the currency based on identification information indicating results of identification of the currency performed by the identification portion 3. In determining the destination, if the paper currency is identified as a genuine bill by the identification portion 3, the destination of the bill is determined according to the method of running the storage compartments 8 and 9. For example, in one method of running them in such a way that paper currencies of a high denomination (e.g., Japanese 10,000-yen denomination) are received in the storage compartment 8, if the kind of the currency is identified as the high denomination bill by the identification portion 3, the control portion 104 determines the storage compartment 8 as the destination of the currency.

If the paper currency is identified as a genuine bill by the identification portion 3 but judged to have been fouled or broken (i.e., unsuited for circulation), the control portion 104 determines the reject storage 5 as the destination, because fouled or broken paper currencies are not suited for circulation.

Furthermore, if the paper currency is identified as a non-genuine or dubious bill by the identification portion 3, the control portion 104 determines the reject storage 5 as the destination of the currency, for the following reason. If the currency identified as a non-genuine or dubious bill by the identification portion 3 were again delivered, the regulations would be violated.

If the paper currency is identified as a bill of an unidentifiable denomination by the identification portion 3, as a bill having abnormal dimensions, or as a bill from which unique information cannot be acquired, then the control portion 104 determines the reject stacker 11 of the cash reception-delivery portion 1 as the destination of the currency, because it is not accepted as a paper currency and should be returned to the user.

In this way, those of the paper currencies identified by the identification portion 3 whose denominations cannot be discerned and unique information cannot be read or acquired are conveyed into the cash reception-delivery portion 1 without via the temporal storage 4 and returned to the user. The paper currency handling apparatus 106 conveys other paper currencies (genuine bills, counterfeit bills, and dubious bills) into the temporal storage 4 before being conveyed into destinations determined by the control portion 104.

Subsequently, processing for receiving entered money during transactions of received paper currencies using the paper currency handling apparatus 106 is described. The processing for receiving entered money shows the results of counting of the paper currencies on the console portion 112. The processing also shows the processing of the paper currency handling apparatus 106 when the currencies are conveyed into the destinations determined by the control portion 104 after prompting the user to check the sum of the money entered by the user. During the confirmation of the sum of entered money displayed on the console portion 112, if the user depresses the aforementioned return button to cancel the money deposit transaction, the paper currencies temporarily stored in the temporal storage 4 are returned to the cash reception-delivery portion 1.

The paper currency handling apparatus 106 conveys out the paper currencies from the temporal storage 4 into the conveyance path 2 according to the destinations determined by the control portion 104. The paper currencies conveyed in the conveyance path 2 are again identified by the identification portion 3 in a manner described later. The currencies are monitored by the passage sensor 6 over the conveyance path 2. The gate 7 is switched. The currencies are conveyed into destinations (storage compartment 8, storage compartment 9, and reject storage compartment 5) determined by the control portion 104 and received in the compartments.

Finally, during payment transactions included in transactions for delivering paper currencies using the paper currency handling apparatus 106, the apparatus 106 pays out a given number of currencies at a time from a storage compartment for each denomination such as the storage compartment 8 or 9. The identification portion 3 identifies the currencies, which are then received in the cash reception-delivery portion 1 and paid out to the user. At this time, if rejection of delivery of a paper currency takes place, the currency is received in the temporal storage 4. A paper currency corresponding to the lack is supplied from the storage compartment 8 or 9 and paid out.

With respect to the temporal storage 4 for temporally storing paper currencies, different structures of the temporal storage 4 are compared in the following description.

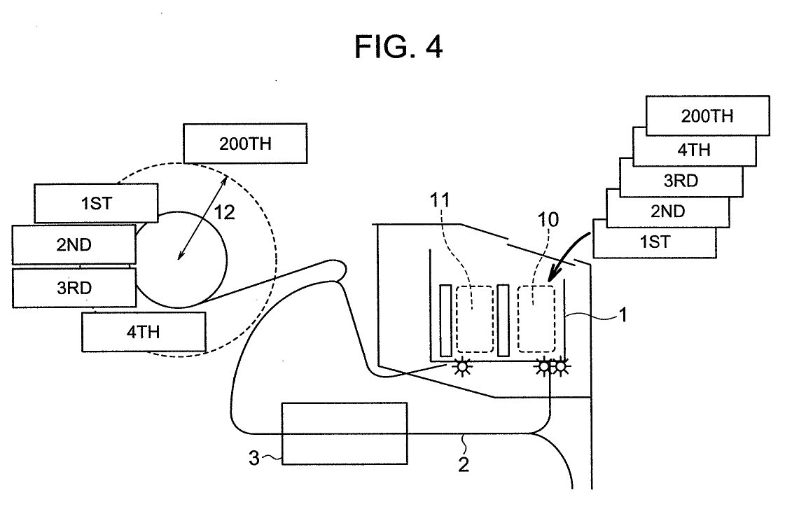

FIG. 4 shows a part of the paper currency handling apparatus 106 having the temporal storage 4 in which paper currencies are wound around a rotary drum and stored. The temporal storage 4 where paper currencies are wound around a rotary drum and stored can be referred to as a winding type temporal storage because the currencies are wound around the rotary drum. This has the feature that if stored paper currencies have various sizes, it is quite rare within the temporal storage 4 that the order of paper currencies when entered money is counted is different from the order of paper currencies when the entered money is received. Therefore, by adopting the winding type temporal storage, paper currencies can be conveyed to their destinations from the temporal storage 4, using the order of paper currencies when entered money is counted, their positions, and identification information.

However, if the number of paper currencies increases, the diameter 12 of the winding portion of the winding type temporal storage 4 is increased. Consequently, it is difficult to satisfy the need for miniaturization of the apparatus and the need for larger capacity at the same time. Furthermore, parts used in the temporal storage 4 in which paper currencies are wound around a rotary drum and stored include special parts such as the drum of the winding portion and tape for winding in paper currencies. Therefore, it is more costly to manufacture and maintain the winding type than a temporal storage described next.

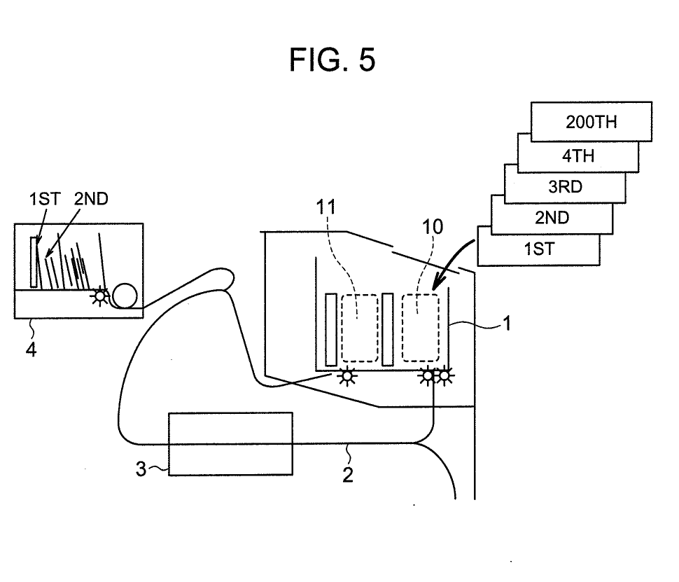

FIG. 5 is a view showing a part of the paper currency handling apparatus 106 having the temporal storage 4 in which paper currencies are stacked and stored. The temporal storage 4 in which paper currencies are stacked on top of each other and stored is simple in structure similarly to the storage compartments 8 and 9. Because paper currencies are stacked, it can be referred to as a stack type temporal storage. This stack type temporal storage 4 can be manufactured and maintained at lower cost than the winding type temporal storage of FIG. 4 in which paper currencies are wound around a rotary drum and stored. Furthermore, a decrease in size and an increase in capacity can be accomplished.

Where higher denomination paper currencies and lower denomination paper currencies are considerably different in size such as EURO currencies, the stack type temporal storage 4 are fabricated in conformity with the larger paper currencies, because if the storage is designed in conformity with smaller paper currencies, larger paper currencies cannot be stored. If larger and smaller paper currencies are stored in this temporal storage at the same time, the posture of the smaller currencies is not stable. Consequently, the order of paper currencies accommodated in the temporal storage 4 may be different between when entered money is counted and when entered money is received. Therefore, it is unsuitable for the temporal storage 4 where paper currencies are stacked on top of each and stored to convey paper currencies from the temporal storage 4 to destinations, using the order of paper currencies when entered money is counted, their positions, and identification information.

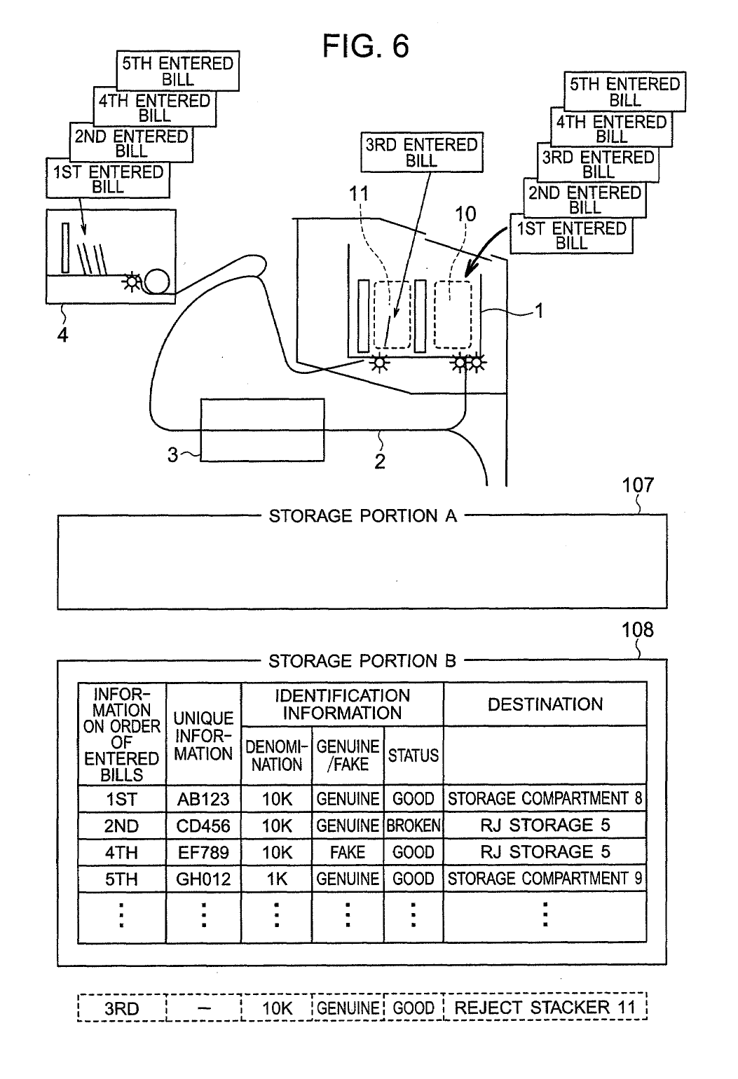

FIG. 6 shows the paper currency handling apparatus 106 to which the stack type temporal storage 4 of FIG. 5 is applied, as well as contents stored in the first storage portion (A) 107 and the second storage portion (B) 108 when processing for counting entered money is performed. During the processing for counting entered money, the identification portion 3 reads the unique information about the paper currencies and identifies their denominations, genuine/fake, or status. These kinds of information read and identified by the identification portion 3 are stored in the storage portion 108. When the processing for counting entered money is performed, nothing is stored in the storage portion 107.

The paper currency handling apparatus 106 conveys paper currencies accepted from users into the conveyance path 2 from the hopper 10 of the cash reception-delivery portion 1. When the currencies conveyed out pass through the identification portion 3, the identification portion 3 reads unique information (such as a serial number) from each currency or identifies its denomination, genuine/fake, or status. The control portion 104 determines destinations of the currency based on the identification information (denomination, genuine/fake, or status) identified by the identification portion 3. Determination of the destinations of paper currencies have been already described in detail and so its description is omitted here. The storage portion 108 stores the unique information read by the identification portion 3, identification information identified, destinations determined by the control portion 104, and information about the order of received currencies while interrelating these kinds of information with each other.

The processing for counting entered money is described in further detail by referring to FIG. 6. In this case, it is assumed that the storage compartment 8 is set to accommodate higher denomination currencies (such as Japanese 10,000-yen denomination) and that the storage compartment 9 is set to accommodate lower denomination currencies (such as Japanese 1,000-yen denomination) during operation.

The identification portion 3 reads “AB123” as unique information about the first paper currency. With respect to identification information, the identification portion identifies the denomination as 10,000-yen denomination, identifies the currency as genuine, and identifies the status as good. Accordingly, the control portion 104 determines the storage compartment 8 for 10,000-yen denomination as a destination according to the aforementioned method of determining destinations of paper currencies. “AB123” is stored as the unique information about the first currency into the storage portion 108. Regarding identification information, 10,000-yen denomination is determined as the denomination of the currency (in FIG. 6, the denomination is indicated by “10K”). The currency is identified as a genuine currency. The status is identified as good. The storage compartment 8 is stored as the destination into the storage portion 108.

The identification portion 3 reads “CD456” as unique information about the second paper currency. With respect to identification information, the identification portion identifies the denomination as 10,000-yen denomination, identifies the currency as genuine, and identifies the status as being broken. Accordingly, the control portion 104 determines the reject storage 5 as a destination according to the aforementioned method of determining destinations of paper currencies. “CD456” is stored as the unique information about the second currency into the storage portion 108. Regarding identification information, 10,000 yen-denomination is determined as the denomination of the currency (in FIG. 6, the denomination is indicated by “10K”). The currency is identified as a genuine currency. The status is identified as being broken (indicated by “broken” in FIG. 6). The reject storage 5 is stored as the destination in the storage portion 108 (indicated by RJ storage 5 in FIG. 6).

The identification portion 3 cannot read unique information about the third paper currency. Accordingly, the control portion 104 determines the reject stacker 11 of the cash reception-delivery portion 1 as the destination according to the aforementioned method of determining the destination of the currency. Regarding paper currencies for which the rejection stacker 11 has been determined as their destination, the storage portion 108 does not store identification information or other information. The currencies are conveyed into the reject stacker 11 of the cash reception-delivery portion 1.

The identification portion 3 reads “EF789” as the unique information about the fourth paper currency. With respect to identification information, the identification portion identifies the currency as 10,000-yen denomination, identifies the currency as counterfeit (non-genuine or dubious bill), and identifies the status as good. Regarding paper currencies identified as non-genuine or dubious bills by the identification portion 3, the control portion 104 determines the reject storage 5 of the cash reception-delivery portion 1 as their destination according to the aforementioned method of determining destinations of paper currencies. With respect to the fourth paper currency, “EF789” is stored as unique information into the storage portion 108. Regarding identification information, “10,000-yen denomination” is stored as the denomination into the storage portion 108. “Fake” is stored as genuine/false into the storage portion 108. “Good” is stored as the status into the storage portion 108. The reject storage 5 is stored as the destination into the storage portion 108.

The identification portion 3 reads “GH012” as unique information about the fifth paper currency. With respect to identification information, the denomination is identified as 1,000-yen denomination. Genuine/false is identified as genuine. The status is identified as good. Therefore, the control portion 104 determines the storage compartment 9 for 1,000-yen denomination currencies as the destination according to the aforementioned method of determining destinations of paper currencies. “GH012” is stored as unique information about the fifth paper currency into the storage portion 108. With respect to identification information, 1,000-yen denomination (represented as 1K in FIG. 6) is identified as the denomination. Genuine/false is identified as genuine. The status is identified as good. The storage compartment 9 is stored as the destination into the storage portion 108.

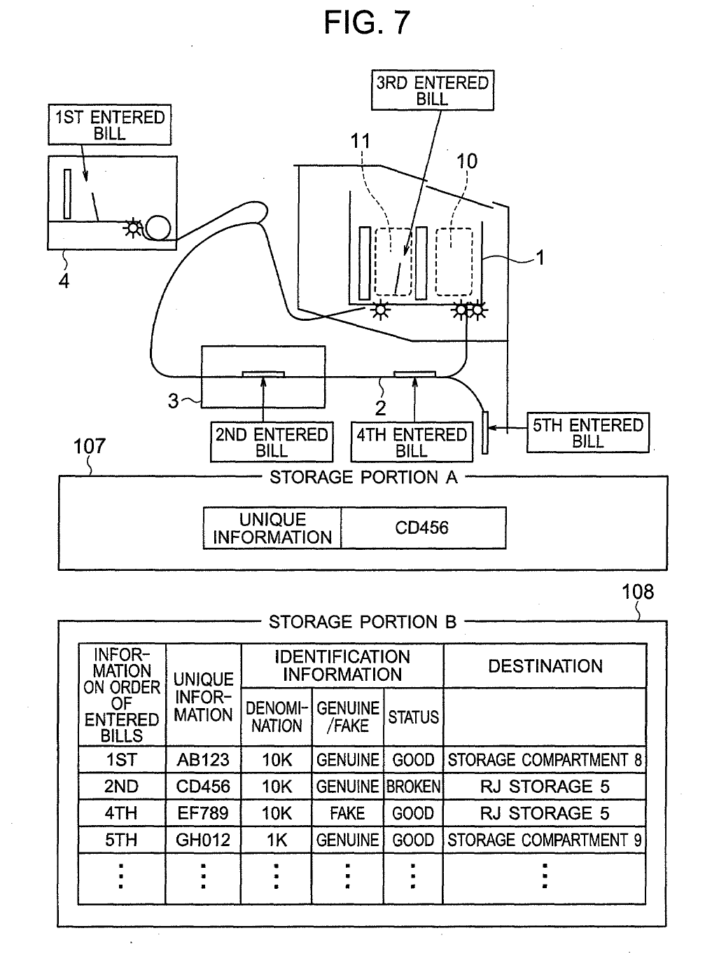

FIG. 7 shows data stored in the storage portions 107 and 108 when paper currencies are conveyed out from the temporal storage 4 and the processing for receiving entered money is being performed after unique information about each paper currency, identification information, information about the order of reception of the currencies, and destinations are stored in the storage portion 108 by the processing for counting the entered money as described in connection with FIG. 6.

When entered money is received, the identification portion 3 reads unique information about each paper currency and compares the read unique information with the unique information stored in the storage portion 108 on each paper currency. Consequently, if the order of paper currencies accommodated in the temporal storage 4 is different between when entered money is counted and when entered money is received, the paper currency handling apparatus 106 is prevented from conveying the currencies to incorrect destinations.

More specifically, the paper currency handling apparatus 106 conveys out paper currencies accommodated in the temporal storage 4 to the conveyance path 2 one by one. When the currency conveyed out passes across the identification portion 3, the identification portion 3 reads unique information from the currency. The storage portion 107 stores the unique information read by the identification portion 3. Subsequently, the control portion 104 compares the currency unique information stored in the storage portion 107 with the unique information stored in the storage portion 108. Where the result of the comparison indicates that the unique information stored in the storage portion 107 is the same as the unique information stored in the storage portion 108 or both kinds of information have a given degree of proximity or similarity, the destination associated with the unique information stored in the storage portion 108 is determined as the destination of the currency by the control portion 104. Where the result of comparison indicates that the unique information stored in the storage portion 107 is not the same as the unique information stored in the storage portion 108 or both kinds of unique information do not have the given degree of proximity, the comparison is repeated. That is, the control portion 104 searches the storage portion 108 for the unique information that is the same or has the given degree of proximity to the unique information stored in the storage portion 107. The destination associated with the unique information is determined as the destination of the paper currency by the control portion 104. The paper currency handling apparatus 106 conveys the paper currency to the determined destination through the conveyance path 2.

Consequently, if the order of paper currencies accommodated in the temporal storage 4 is different between when entered money is counted and when the entered money is received, the paper currency handling apparatus 106 can convey the currencies to destinations in accordance with the identification information arising when the entered money is counted.

In FIGS. 6 and 7, during counting of entered money, paper currencies for which the reject stacker 11 is determined as their destinations by the control portion 104 are intact conveyed to the reject stacker 11 without being conveyed to the temporal storage 4. This makes unnecessary for the storage portion 108 to store unique information or other information concerning the paper currencies for which the reject stacker 11 has been determined as their destination. Because information not associated with the processing for receiving entered money is not stored, the processing for determining destinations when entered money is received can be conducted more efficiently.

The storage portion 108 can store information such as unique information also regarding paper currencies (such as the third currency in FIG. 6) for which the reject stacker 11 has been determined as its destination during counting of entered money by the control portion 104. The information described so far can be managed together with the users' accounts. Users who frequently use paper sheets conveyed to the reject stacker 11 can be identified. This can lead to identification of malicious users.

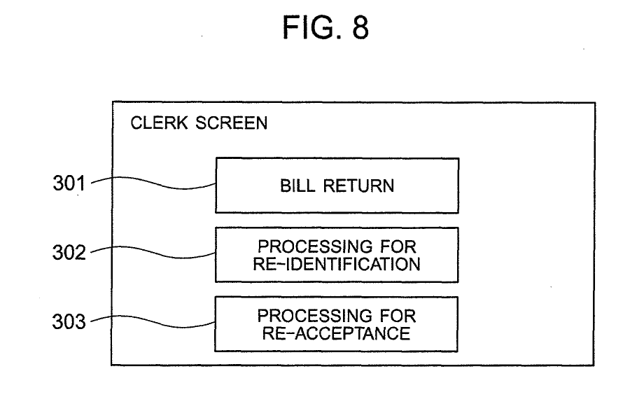

FIG. 8 is a screen displayed on the console portion 112 by the ATM 103 by automatic detection of an error by means of the paper currency handling apparatus 106 or by a manipulation of a clerk in charge when the error occurs at the time when the user cancels the money deposit transaction and the paper currencies are returned from the temporal storage 4 to the cash reception-delivery portion 1 after the counting of entered money described in connection with FIG. 6.

When the paper currency handling apparatus 106 returns paper currencies from the temporal storage 4 to the cash reception-delivery portion 1, if the currencies are overlapped to thereby make it impossible for the identification portion 3 to read unique information or if unique information corresponding to the unique information in the storage portion 107 does not exist in the storage portion 108, the currency handling apparatus 106 gives a notification to the automated teller machine (ATM) 103 and informs the outside that conveyance of paper currencies has been stopped. Furthermore, the console portion 112 displays this screen to prompt the clerk in charge to perform manipulations.

The console portion 112 detects depression of keys 301-303 by the clerk in charge. The body control portion 114 instructs the paper currency handling apparatus 106 to execute processing corresponding to the keys 301-303.

The “bill return” key 301 is used to give an instruction for executing processing for returning paper currencies remaining in the conveyance path 2 or in the temporal storage 4 to the cash reception-delivery portion 1. The “re-identification processing” key 302 is used to give an instruction for executing processing for receiving paper currencies into the temporal storage 4 or the reject stacker 11, based on identification information related to unique information in the storage portion 108 corresponding to the unique information read by the identification portion 3 when paper currencies returned to the cash reception-delivery portion 1 are conveyed out into the conveyance path 2 and the paper currencies conveyed in the conveyance path 2 pass through the identification portion 3. The “re-accepting processing” key 303 is used to give an instruction for executing processing for causing paper currencies received in the temporal storage 4 to be conveyed to the storage compartment 8 or 9, the reject stacker 11, or the reject storage 5.

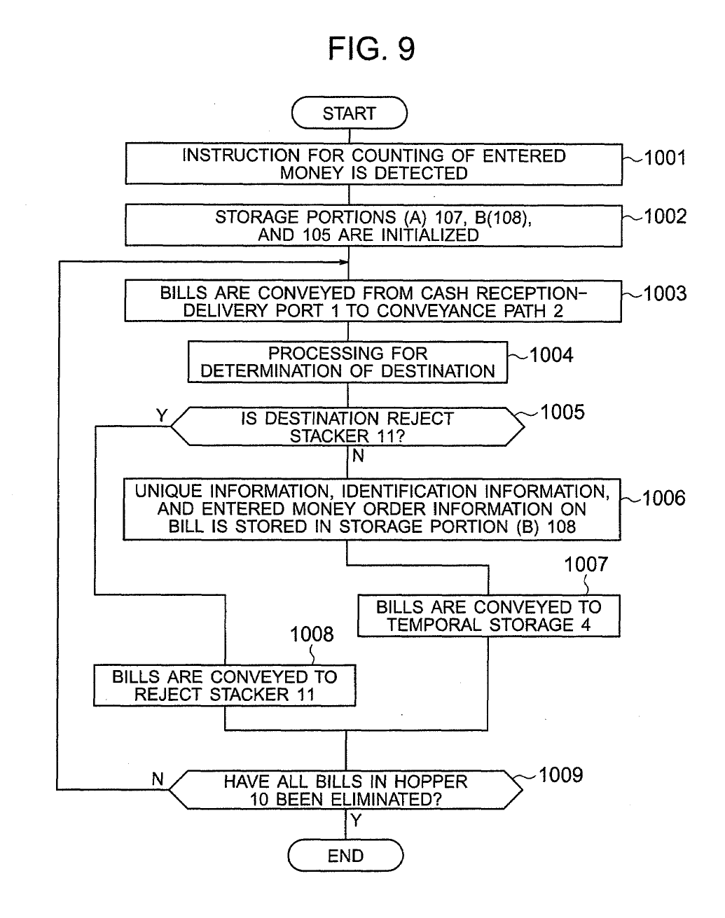

Specific examples of the transaction processing of the present invention are hereinafter described by referring to FIGS. 9 to 12. Here, a case is described where paper currencies for which the reject stacker 11 has been determined as their destination are returned to the stacker 11 by the paper currency handling apparatus 106 without storing information in the storage portion 108.

FIG. 9 is a flowchart illustrating the processing for counting entered money. The ATM 103 detects a user's manipulation for a money deposit transaction by means of the console portion 112 and issues an instruction to the paper currency handling apparatus 106 to start processing for counting entered money for the money deposit transaction. The handling apparatus 106 detects the instruction for counting entered money (step 1001) and initializes the storage portion 105, storage portion (A) 107, and storage portion (B) 108 (step 1002). The cash reception-delivery portion 1 conveys paper currencies entered by the user into the conveyance path 2 (step 1003). When the currencies conveyed in the conveyance path 2 pass through the identification portion 3, processing for determining destinations is performed by the identification portion 3 and control portion 104 (step 1004). In the processing for determining destinations, the destinations are determined by the aforementioned method of determining destinations. Although not described in detail here, the identification portion 3 reads unique information about each paper currency and identifies the currency in terms of its denomination, genuine/fake, or status. The control portion 104 determines destinations of the paper currencies based on identification information produced by the identification portion 3 that has identified them.

Subsequently, the control portion 104 makes a decision at step 1004 as to whether or not the destination is the reject stacker 11 (step 1005). If the destination is the reject stacker 11 (decision at step 1005 is YES), the currency is conveyed into the reject stacker 11 of the cash reception-delivery portion 1 (step 1008).

If the decision at step 1005 is that the destination is not the reject stacker 11, the storage portion 108 stores unique information, identification information, destination, and information about the order of deposits of currencies by associating these information with each other (step 1006). The currency is conveyed to the temporal storage 4 (step 1007).

The steps 1003 through 1008 are repeated until all the paper currencies in the hopper 10 of the cash reception-delivery portion 1 are eliminated (step 1009).

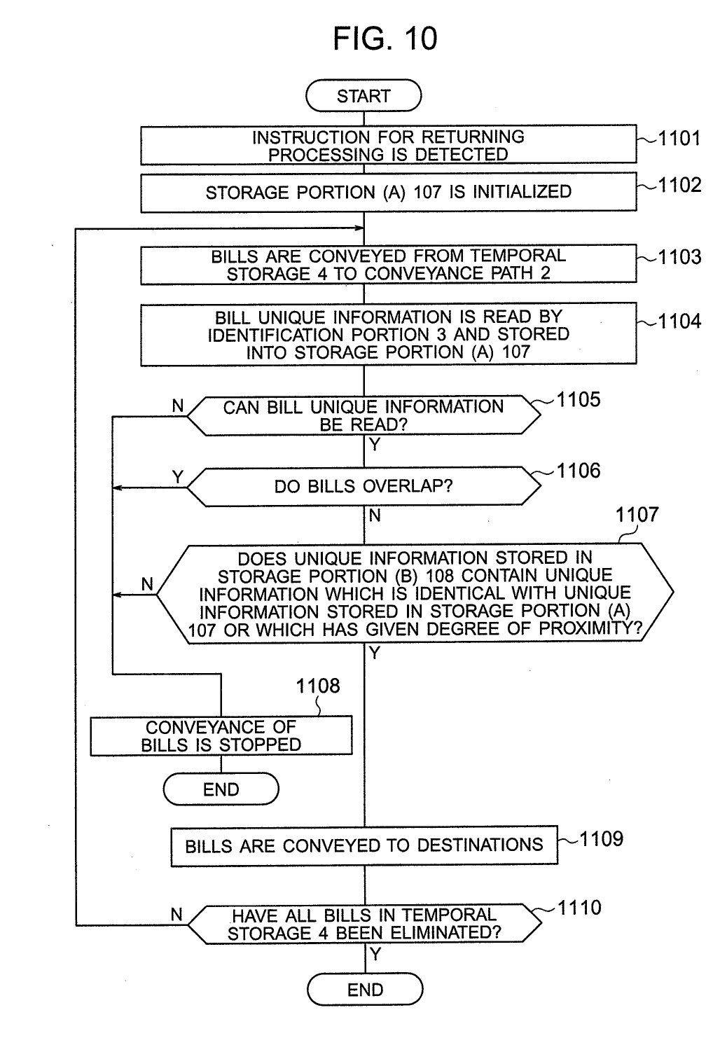

FIG. 10 is a flowchart illustrating processing performed where the money deposit transaction is cancelled by the user after the processing of counting entered money described previously in connection with FIG. 9. Where a notification of cancellation of the money deposit transaction is given, the paper currency handling apparatus 106 returns the currency from the temporal storage 4 to the reject stacker 11 of the cash reception-delivery portion 1. Operations performed at this time are described.

The ATM 103 detects the canceling manipulation of the user's money deposit transaction by the console portion 112 and instructs the paper currency handling apparatus 106 to start processing for returning. The handling apparatus 106 detects the instruction for the processing of returning (step 1101) and initializes the storage portion 107 (step 1102). The paper currencies received into the temporal storage 4 by the processing for counting entered money are conveyed out into the conveyance path 2 by the temporal storage 4 (step 1103). When the currencies conveyed in the conveyance path 2 pass through the identification portion 3, the identification portion 3 reads unique information about each paper currency. The storage portion 107 stores the unique information read by the identification portion 3 (step 1104).

If the identification portion 3 cannot read the unique information (decision at step 1105 is NO), if the paper currency overlaps any other paper currency (decision at step 1106 is YES), or if the identification portion 3 has successfully read the unique information but the unique information stored in the storage portion 108 does not have the same information as the unique information stored in the storage portion 107 or information having a given degree of proximity (decision at step 1107 is NO), it is not the case where the paper currency handling apparatus 106 can determine destinations only according to the result of the identification performed during counting of entered money and so conveyance of paper currency is stopped (step 1108). It is determined by the identification portion 3 as to whether or not paper currencies are overlapped by detecting the shape, size, and thickness of each paper currency.

If the unique information can be read (decision at step 1105 is NO), if the paper currency does not overlap any other paper currency (decision at step 1106 is NO), and if the unique information stored in the storage portion 108 contains unique information that is the same as the unique information stored in the storage portion 107 or has a given degree of proximity (decision at step 1107 is YES), then the paper currency is conveyed into the destination associated with the unique information in the storage portion 108 that corresponds to the unique information in the storage portion 107 (step 1109).

The paper currency handling apparatus 106 repeats the steps 1103 through 1109 until all the paper currencies in the temporal storage 4 are eliminated (step 1110).

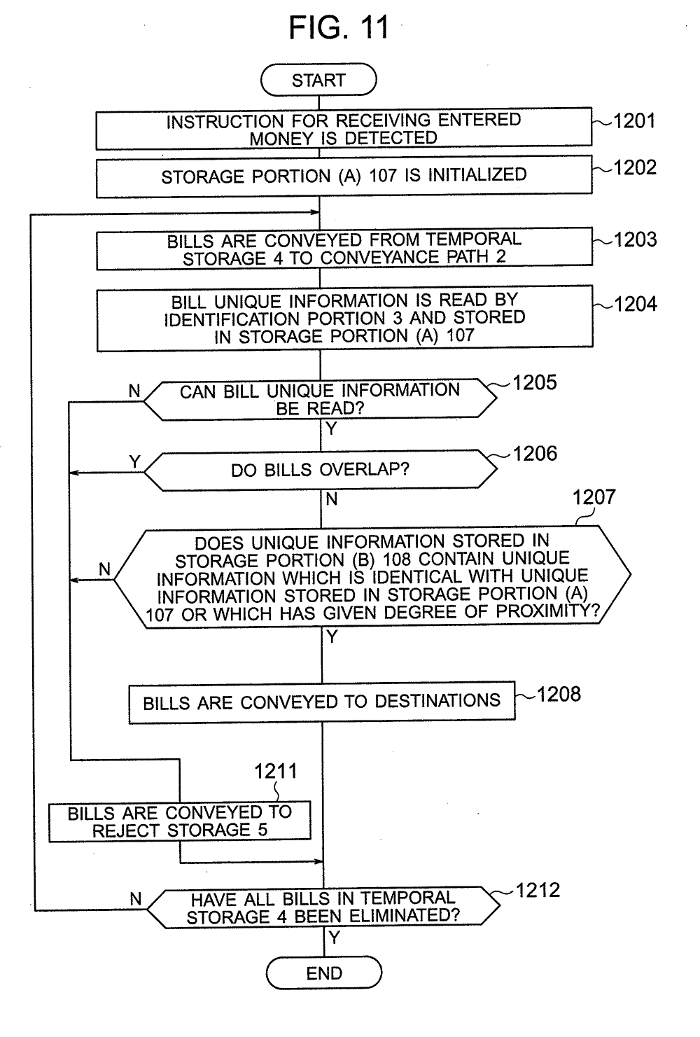

FIG. 11 is a flowchart illustrating the processing for accepting entered money in a case where the user has established the money deposit transaction after the processing for counting entered money as described in connection with FIG. 9. Where a notice of the setting of the money deposit transaction is given to the paper currency handling apparatus 106 after the end of conveyance of the paper currency from the cash reception-delivery portion 1 into the temporal storage 4, the handling apparatus 106 conveys the currency either to the storage compartment 8 or 9. Operations performed at this time are described below.

The ATM 103 detects a user's manipulation for setting the money deposit transaction by the console portion 112 and instructs the paper currency handling apparatus 106 to start acceptance of the entered money. The paper currency handling apparatus 106 detects the instruction for acceptance of the entered money and starts processing for accepting the paper currency (step 1201). The paper currency handling apparatus 106 initializes the storage portion 107 (step 1202).

The temporal storage 4 causes the paper currencies accommodated in the temporal storage 4 by the processing for counting entered money to be conveyed out into the conveyance path 2 (step 1203). When each paper currency conveyed into the conveyance path 2 passes through the identification portion 3, the identification portion 3 reads the unique information about the currency. The storage portion 107 stores the unique information read by the identification portion 3 (step 1204).

If the unique information cannot be read (decision at step 1205 is NO), if the paper currency overlaps any other paper currency (decision at step 1206 is YES), or if the identification portion 3 has successfully read the unique information but the unique information stored in the storage portion 108 does not have the same information as the unique information stored in the storage portion 107 or information having a given degree of proximity (decision at step 1207 is NO), the paper currency is conveyed into the reject storage 5 (step 1211).

If the unique information can be read (decision at step 1205 is YES), if the paper currency does not overlap any other paper currency (decision at step 1206 is NO), or if the identification portion 3 has successfully read the unique information but the unique information stored in the storage portion 108 has information identical with unique information stored in the storage portion 107 or information having a given degree of proximity (decision at step 1207 is YES), the paper currency is conveyed into the destination related to the unique information in the storage portion 108 corresponding to the unique information in the storage portion 107 (step 1208).

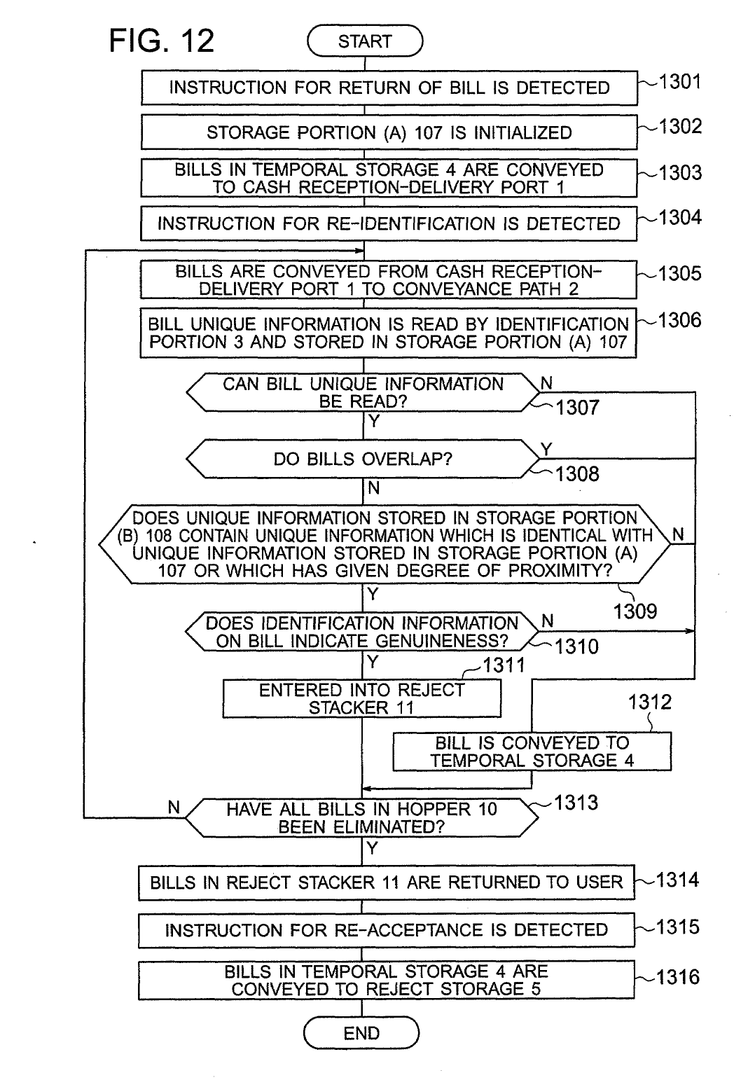

FIG. 12 is a flowchart illustrating processing performed after conveyance of paper currencies is stopped (step 1108 of FIG. 10) during the returning processing described in connection with FIG. 10.

The clerk in charge switches the ATM from transaction mode to clerk mode and depresses the “bill return” key 301 (FIG. 8).

The main body control portion 114 detects the clerk's manipulation for “bill return” by the console portion 112 and gives a bill returning instruction to the paper currency handling apparatus 106 to start “bill return” of the paper currency. The handling apparatus 106 detects the bill-returning instruction (step 1301) and initializes the storage portion 107 (step 1302). The storage portion 108 holds the information stored at the time of counting of entered paper currencies without being initialized. The paper currencies stored in the temporal storage 4 are conveyed into the conveyance path 2 by the paper currency handling apparatus 106 to return them to the reject stacker 11 of the cash reception-delivery portion 1 (step 1303).

In some cases, the paper currencies returned to the cash reception-delivery portion 1 contain non-genuine or dubious paper currencies and thus cannot be intact transferred to the user. Therefore, it is necessary for the clerk to identify each bill again by means of the paper currency handling apparatus 106 in order to deliver only genuine bills to the user.

Accordingly, the clerk depresses “re-identification” key 302 (FIG. 8). The main body control portion 114 detects the clerk's manipulation for “re-identification” by the console portion 112 and gives a re-identification instruction to the paper currency handling apparatus 106 to start processing for “re-identification” of the paper currency. The handling apparatus 106 detects the re-identification instruction (step 1304) and conveys the currencies from the cash reception-delivery portion 1 into the conveyance path 2 (step 1305).

In conveying the currencies as described above, the identification portion 3 reads unique information about the currency and stores the unique information into the storage portion 107 (step 1306).

If the unique information can be read (decision at step 1307 is YES), the currency does not overlap any other paper currency (decision at step 1308 is YES), the unique information stored in the storage portion 108 contains information that is identical with the unique information stored in the storage portion 107 or has a given degree of proximity (decision at step 1309 is YES), and genuine/fake of the paper currency of the identification information stored in the storage portion 108 is genuine (decision at step 1310 is YES), then the currency is conveyed to the reject stacker 11 (step 1309).

On the other hand, if the unique information cannot be read (decision at step 1307 is YES), the paper currency overlaps any other paper currency (decision at step 1308 is YES), the unique information stored in the storage portion 108 does not have information that is identical with the unique information stored in the storage portion 107 or has a given degree of proximity (decision at step 1309 is NO), and if the paper currency is a counterfeit or dubious bill (decision at step 1310 is NO), then the currency is conveyed into the temporal storage 4 through the conveyance path 2 (step 1312).

The steps 1305 through 1312 are repeated until the paper currencies held in the hopper 10 of the cash reception-delivery portion 1 are all eliminated (step 1313).

Because the paper currencies accommodated in the reject stacker 11 are genuine bills, they are returned to the user (step 1311). In the cash reception-delivery portion 1, there is a partition between the hopper 10 and the reject stacker 11 and therefore, if genuine bills are conveyed into the reject stacker 11 before all the paper currencies in the hopper 10 are eliminated in step 1313, it is unlikely that bills in the hopper 10 and bills in the reject stacker 11 are mixed.

Finally, the clerk depresses “re-acceptance” key 303 (FIG. 8). The main body control portion 114 detects the clerk's manipulation for processing for “re-acceptance” by the console portion 112 and gives a re-acceptance instruction to the paper currency handling apparatus 106 to start the processing for “re-acceptance” of paper currencies. The handling apparatus 106 detects the instruction for re-acceptance and conveys the paper currencies conveyed to the temporal storage 4 in step 1312 into the reject storage 5 from the temporal storage 4 (step 1316).

In the present embodiment, when paper currencies are conveyed from the temporal storage 4 to their destinations, the control portion 104 determines destinations associated with the unique information in the storage portion 108 corresponding to the unique information read by the identification portion 3 as the destinations of the paper currencies. Only the unique information is read and compared. This permits processing to be performed at higher speed. This leads to a decrease in the length of the conveyance path and miniaturization of the apparatus.

As a different form, when paper currencies are conveyed from the temporal storage 4 into their destinations, the identification portion 3 may be made to identify denomination, genuine/fake, or status of each paper currency again, in addition to the unique information. Based on the identification information, the control portion 104 may determine destinations, which are then compared with destinations in the storage portion 108. In this way, final destinations may be determined. However, the processing is performed at lower speed because it is necessary to again judge whether each paper currency is genuine or counterfeit, unlike the aforementioned embodiment where data produced during counting of entered money is handled.

For example, for the same paper currency, the result of identification of the bill may be different between when entered money is counted and when the entered money is received. As a result, during the acceptance of the entered money, a non-genuine or dubious bill may be found. Assuming such a case, the control portion 104 compares the destination determined during counting of entered money and the destination determined during acceptance of the entered money. If any destination is the reject storage 5, i.e., when a non-genuine or dubious bill is found, the destination in the storage portion 108 is modified to the reject storage 5. The paper currency is conveyed to the modified destination. As a result, the paper currency handling apparatus 106 can recover any non-genuine or dubious bill found during acceptance of entered money into the apparatus. It is possible to thoroughly prevent non-genuine or dubious paper currencies from being circulated into the world.

In a further conceivable form, all of paper currencies including genuine and counterfeit bills are temporarily held in the temporal storage without using the unique information or the result of identification as to whether they are genuine or counterfeit performed during counting of entered money. Destinations are determined according to the result of the identification as to whether each bill is genuine or counterfeit, the identification being performed during the processing for acceptance of paper currencies. In this case, a compartment dedicated to counterfeit paper currencies is mounted on the portion of the conveyance path located behind the identification portion.

In some cases, however, the identification portion 3 may identify a paper currency as a non-genuine or dubious bill during counting of entered money but identify the currency as a genuine bill during acceptance of entered money. Therefore, determination of the destination of the currency only based on the result of the identification performed during acceptance of entered money is undesirable for observance of the rules.

During counting of entered money or during acceptance of the entered money, the identification portion 3 identifies each paper currency in terms of denomination, genuine/fake, or status. The storage portion 108 stores the denomination, genuine/fake, or status of the paper currency as identification information. The identification portion 3 may identify the currency in terms of kind (new or old) of the paper currency, posture, the time of issuance, and so on, as well as the denomination, genuine/fake, or status. The storage portion 108 may store kind (new or old) of the currency, posture, and time of issuance as identification information, in addition to denomination, genuine/fake, or status. Consequently, it is possible to carry out various kinds of identification complying with administrator's demands. Each discerned kind can be accommodated into each storage compartment.

In the present embodiment, the storage portion 107 possessed by the identification portion 3 stores unique information. The storage portion 108 stores identification information, unique information, and other information. As a matter of course, the storage portion 105 possessed by the control portion 104 may store all or some of identification information and unique information.

Furthermore, in the present embodiment, unique information is stored in the storage portion 107 as mentioned previously. Unique information read by the identification portion 3 during acceptance of entered money may be intact compared with the unique information stored in the storage portion 108 without being stored.

As described so far, a paper currency handling apparatus can be offered, which if the order of paper currencies within the temporal storage 4 is different between when entered money is counted and when entered money is received, can determine destinations of the paper currencies from the results of identification of them performed during the counting of entered money.

It is to be noted that the aforementioned determination of destinations by making use of reading of unique information performed during processing for counting entered money and during processing for receiving entered money is merely one embodiment of the present invention. The present invention is not limited to the above embodiment but rather can be applied to any case where management of paper currencies can be facilitated and made stricter by storing unique information and identification information about each paper currency or destination while relating these sets of information to each other.

It should be further understood by those skilled in the art that although the foregoing description has been made on embodiments of the invention, the invention is not limited thereto and various changes and modifications may be made without departing from the spirit of the invention and the scope of the appended claims.

1. A paper currency handling apparatus comprising:
a conveyance path along which paper currencies are conveyed;
an identification portion for identifying the paper currencies conveyed in the conveyance path;
storage portions for storing identification information indicating results of identification of the currencies performed by the identification portion; and
a control portion for controlling the portions;
wherein the identification portion reads unique information about the paper currencies conveyed in the conveyance path; and
wherein the storage portions store the unique information about the currencies read by the identification portion and the identification information about the currencies identified by the identification portion in such a manner that these two kinds of information are associated with each other.

2. A paper currency handling apparatus as set forth in claim 1, further comprising a temporal storage for temporarily storing paper currencies,
wherein said identification portion reads unique information about each paper currency conveyed into the temporal storage via the conveyance path,
wherein said control portion determines destinations of paper currencies conveyed out from the temporal storage based on identification information about paper currencies identified by the identification portion, and
wherein said storage portions store the unique information and the identification information by associating the unique information with the identification information.

3. A paper currency handling apparatus as set forth in claim 2, wherein said identification portion reads unique information about each paper currency conveyed out from the temporal storage, and
wherein said control portion determines, as a destination of the paper currency conveyed out from the temporal storage, the destination associated with the unique information stored in the storage portions which corresponds to the unique information read by the identification portion about the paper currency conveyed out from the temporal storage.

4. A paper currency handling apparatus as set forth in claim 2, wherein said temporal storage includes a stack type temporal storage where paper currencies are stacked and stored.

5. A paper currency handling apparatus as set forth in claim 1, wherein the unique information about said paper currency includes a serial number carried thereon.

6. A paper currency handling apparatus as set forth in claim 1, wherein said identification information includes at least information indicating whether the paper currency is genuine or counterfeit.

7. A paper currency handling apparatus comprising:
a temporal storage for temporarily storing paper currencies;
a conveyance path along which paper currencies are conveyed;
an identification portion mounted to be capable of reading unique information about each paper currency conveyed into the temporal storage via the conveyance path;
a control portion for determining a destination of each paper currency conveyed from the temporal storage to the conveyance path based on identification information about the paper currency, the identification information indicating results of identification of the paper currency performed by the identification portion, regarding each paper currency conveyed into the temporal storage from the conveyance path; and
storage portions for storing the unique information read by the identification portion and the destination by associating said unique information with the identification information.

8. A paper currency handling apparatus as set forth in claim 7, wherein said identification portion reads unique information about each paper currency conveyed from the temporal storage to the conveyance path, and wherein said control portion determines, as a destination of the paper currency conveyed from the temporal storage to the conveyance path, the destination associated with the unique information stored in the storage portions which corresponds to the unique information read by the identification portion about the paper currency conveyed from the temporal storage to the conveyance path.

9. A paper currency handling apparatus as set forth in claim 8, wherein in performing entered money counting processing in which said conveyance path conveys paper currencies from a cash reception-delivery portion into said temporal storage via said identification portion, the control portion determines said cash reception-delivery portion as a destination of a paper currency in a case where said identification portion cannot read unique information from the paper currency conveyed from the conveyance path into the temporal storage.

10. A paper currency handling apparatus as set forth in claim 8, further comprising storage compartments for accommodating entered paper currencies,
wherein in performing entered money receiving processing in which paper currencies are conveyed from the temporal storage into the storage compartments via the identification portion, the control portion determines one of the storage compartments incapable of delivering paper currencies as a destination of a paper currency when the identification portion cannot read unique information from the paper currency conveyed from the temporal storage to the conveyance path.

11. A paper currency handling apparatus as set forth in claim 8,
wherein in performing returning processing in which the conveyance path conveys paper currencies to the cash reception-delivery portion from the temporal storage via the identification portion, the control portion stops conveyance of paper currencies to the conveyance path in a case where the identification portion cannot read unique information about the paper currencies conveyed from the temporal storage to the conveyance path.

12. A paper currency handling apparatus as set forth in claim 7, wherein said temporal storage includes a stack type temporal storage in which paper currencies are stacked and stored.

13. A paper currency handling apparatus as set forth in claim 12, wherein said conveyance path conveys paper currencies to the destination.

14. A paper currency handling apparatus as set forth in claim 7, wherein the unique information about said paper currency includes a serial number carried thereon.

15. A paper currency handling apparatus as set forth in claim 7, wherein said identification information includes at least information indicating whether the paper currency is genuine or counterfeit.

16. A method of handling paper currencies, comprising the steps of:
identifying conveyed paper currencies;
reading unique information about the conveyed paper currencies; and
storing the read unique information about the paper currencies and identification information indicating results of identification of the paper currencies by associating the unique information with the identification information.

17. A method of handling paper currencies, comprising the steps of:
identifying paper currencies conveyed into a temporal storage;
reading unique information about the paper currencies conveyed into the temporal storage;
determining a destination of each paper currency conveyed out from the temporal storage based on identification information indicating results of identification of the paper currency; and
storing the destination and the unique information by associating the destination with the unique information.

18. A method of handling paper currencies as set forth in claim 17, wherein unique information about each paper currency conveyed out from the temporal storage is read, and said destination associated with the stored unique information corresponding to the read unique information about the paper currency is determined as a destination of the paper currency conveyed out from the temporal storage.
